(19) United States
(12) Patent Application Publication
(10) Pub. No.: US 2010/0261090 A1
(43) Pub. Date: Oct. 14, 2010

(54) Cathode catalyst for fuel cell, and membrane-electrode assembly for fuel cell and fuel cell system comprising same

(76) Inventors: Alexey Alexandrovichserov, Yongin-si (KR); Chan Kwak, Yongin-si (KR); Si-Hyun Lee, Yongin-si (KR); Myoung-Ki Min, Yongin-si (KR)

Correspondence Address: CHRISTIE, PARKER & HALE, LLP, PO BOX 7068, PASADENA, CA, 91109-7068, US

(21) Appl. No.: 11/503,398

(22) Filed: Aug. 11, 2006

(30) Foreign Application Priority Data
Aug. 11, 2005 (KR) 10-2005-0073777
Nov. 30, 2005 (KR) 10-2005-0115920

(51) Int. Cl. H01M 8/10; H01M 4/90

(52) U.S. Cl. 429/483; 429/526

(57) ABSTRACT

A cathode catalyst for a fuel cell includes Ru, Fe, and A, where A is Se or S. A cathode catalyst may also include a carbon-based material and crystalline M₁-M₂-Ch and amorphous M₁-M₂-Ch supported on the carbon-based material, where M₁ is a metal selected from the group consisting of Ru, Pt, Rh, and combinations thereof, M₂ is a metal selected from the group consisting of W, Mo, and combinations thereof, and Ch is a chalcogen element selected from the group consisting of S, Se, Te, and combinations thereof.

### CROSS-REFERENCES TO RELATED APPLICATIONS

This application claims priority to and the benefit of Korean Patent Application Nos. 10-2005-0073777 and 10-2005-0115920 filed in the Korean Intellectual Property Office on Aug. 11, 2005 and Nov. 30, 2005, the entire contents of which are incorporated herein by reference.

### BACKGROUND OF THE INVENTION

1. Field of the Invention

The invention relates to a cathode catalyst for a fuel cell, and a membrane-electrode assembly and a fuel cell system including the same. More particularly, the invention relates to a cathode catalyst having activity and selectivity for the reduction reaction of an oxidant and thereby being capable of improving fuel cell performance, and a membrane-electrode assembly and a fuel cell system including the same.

2. Description of the Related Art

A fuel cell is a power generation system for producing electrical energy through an electrochemical redox reaction of an oxidant and a fuel such as hydrogen, or a hydrocarbon-based material such as methanol, ethanol, natural gas, and the like. The polymer electrolyte fuel cell is a clean energy source that is capable of replacing fossil fuels. It has the advantages of high power output density and energy conversion efficiency, operability at room temperature, and of being small-sized and tightly sealed. Therefore, it can be applied to a wide array of fields such as non-polluting automobiles, electricity generation systems, portable power sources for mobile equipment, military equipment, and the like.

Representative exemplary fuel cells include a polymer electrolyte membrane fuel cell (PEMFC) and a direct oxidation fuel cell (DOFC). The direct oxidation fuel cell includes a direct methanol fuel cell that uses methanol as a fuel.

The polymer electrolyte fuel cell has the advantages of high energy density and high power, but also has problems in the need to carefully handle hydrogen gas and the requirement of accessory facilities, such as a fuel reforming processor for reforming methane or methanol, natural gas, and the like in order to produce hydrogen as the fuel gas.

On the contrary, a direct oxidation fuel cell has a lower energy density than that of the gas-type fuel cell but has the advantages of easy handling of the liquid-type fuel, a low operation temperature, and no need for additional fuel reforming processors. Therefore, it has been acknowledged as an appropriate system for a portable power source for small and common electrical equipment.

In the above-mentioned fuel cell system, the stack that generates electricity substantially includes several to many unit cells stacked adjacent to one another, and each unit cell is formed of a membrane-electrode assembly (MEA) and a separator (also referred to as a bipolar plate). The membrane-electrode assembly is composed of an anode (also referred to as a “fuel electrode” or an “oxidation electrode”) and a cathode (also referred to as an “air electrode” or a “reduction electrode”) that are separated by a polymer electrolyte membrane.

A fuel is supplied to the anode and adsorbed on catalysts of the anode, and the fuel is oxidized to produce protons and electrons. The electrons are transferred into the cathode via an out-circuit, and the protons are transferred into the cathode through the polymer electrolyte membrane. In addition, an oxidant is supplied to the cathode, and then the oxidant, protons, and electrons are reacted on catalysts of the cathode to produce electricity, along with water.

The above information disclosed in this background section is only for enhancement of understanding of the background of the invention and therefore, it should be understood that the above information may contain information that does not form the prior art that is already known in this country to a person or ordinary skill in the art.

### SUMMARY OF THE INVENTION

One embodiment of the invention provides a cathode catalyst for a fuel cell having excellent activity and selectivity for the reduction reaction of an oxidant.

Another embodiment of the invention provides a membrane-electrode assembly including the above cathode catalyst. Yet another embodiment of the invention provides a fuel cell system including the above membrane-electrode assembly. According to an embodiment of the invention, a cathode catalyst is provided that includes Ru, Fe, and A, where A is selected from the group consisting of Se and S.

According to another embodiment of the invention, a cathode catalyst is provided that includes a carbon-based material and crystalline M₁-M₂-Ch and amorphous M₁-M₂-Ch supported on the carbon-based material, where M₁ is a metal selected from the group consisting of Ru, Pt, Rh, and combinations thereof, M₂ is a metal selected from the group consisting of W, Mo, and combinations thereof, and Ch is a chalcogen element selected from the group consisting of S, Se, Te, and combinations thereof. According to yet another embodiment of the invention, a membrane-electrode assembly is provided that includes a cathode and an anode facing each other, and a polymer electrolyte membrane interposed therebetween. The anode and the cathode include a conductive electrode substrate and a catalyst layer disposed on the electrode substrate. The cathode catalyst layer includes the above cathode catalyst.

According to still another embodiment of the invention, a fuel cell system is provided that includes at least one electricity generating element, a fuel supplier, and an oxidant supplier. The electricity generating element includes a membrane-electrode assembly and separators arranged at each side thereof. The membrane-electrode assembly includes the above membrane-electrode assembly.

### BRIEF DESCRIPTION OF THE DRAWINGS

FIG. 1 is a schematic a cross-sectional view of a membrane-electrode assembly according to one embodiment of the invention.

FIG. 2 schematically shows the structure of a fuel cell system according to one embodiment of the invention.

FIGS. 3A to 3C are SEM photographs of a cathode catalyst according to Example 1 of the invention.

FIG. 4 is a graph showing an X-Ray diffraction analysis result of a catalyst according to Example 2 of the invention.

FIGS. 5A to 5D are transmission electron microscopy (TEM) photographs of a catalyst according to Example 2 of the invention.

FIG. 6 is a graph showing a measurement result using a Rotating Disk Electrode (RDE) of cathode catalysts according to Example 1 and Comparative Example 1.

FIG. 7 is a graph showing a current density according to a voltage of fuel cells including the catalysts according to Example 2 and Comparative Example 2.

FIG. 8 is a graph showing an X-ray diffraction peak of a catalyst according to Example 1.

### DETAILED DESCRIPTION

Exemplary embodiments of the invention will hereinafter be described in detail with reference to the accompanying drawings.

A fuel cell is a power generation system generating electrical energy from the oxidation of a fuel and reduction of an oxidant. The fuel is oxidized at an anode, and the oxidant is reduced at a cathode.

At a catalyst layer portion of the anode and the cathode, catalysts are provided for promoting the fuel oxidation and oxidant reduction reactions. At the catalyst layer of the anode, platinum-ruthenium is typically used, and at the catalyst layer of the cathode, platinum is typically used.

However, a platinum cathode catalyst has insufficient selectivity for an oxidant reduction reaction, and in a direct oxidation fuel cell, may be depolarized and then inactivated by a fuel that is subject to cross-over to the cathode through the electrolyte membrane. Therefore, research into substitutes for platinum has been conducted.

According to one embodiment of the invention, a Ru-containing cathode catalyst substituted for a platinum-based catalyst is provided. The Ru-containing catalyst has excellent activity and stability for oxygen reduction reactions. The cathode catalyst is Ru—Fe-A, where A is Se or S, which includes Ru and Fe, and either Se or S. Ru—Fe—Se is more preferable in terms of catalyst activity than Ru—Fe—S.

In an embodiment, the Ru-containing catalyst is a semi-amorphous catalyst that has a partial crystalline portion and an additional small portion having a mixed amorphous and crystalline phase. The semi-amorphous catalyst has excellent characteristics compared to a conventional Ru—Se catalyst that is entirely crystalline, because the semi-amorphous catalyst has many surface defects in the mixed amorphous and crystalline phase, and these defects act as catalyst active sites. The catalyst according to an embodiment of the invention has a partial crystalline portion having a particle size in the range of 3 to 4 nm.

In the catalyst in accordance with one embodiment, A is an important component determining the catalyst activity, and therefore the amount of A is most important. According to an embodiment, the amount of A ranges from 3 to 5 mol %. When the amount of A is less than 3 mol %, the improvement of catalyst activity is not sufficient. When it is more than 5 mol %, A covers the surface of Ru and thereby decreases catalyst activity.

In an embodiment, the amount of Ru ranges from 15 to 70 mol %, and the amount of Fe ranges from 15 to 70 mol %. When the amount of Ru is less than 15 mol %, the main catalyst component is too low and thereby catalyst activity may be reduced. When it is more than 70 mol %, the amount of Fe and A decreases and thereby catalyst activity may be lessened. In addition, when the amount of Fe is less than 15 mol %, the amount of Fe is too low to improve catalyst activity. When it is more than 70 mol %, the content of the main component Ru is considerably low and the catalyst activity may be deteriorated.

The Ru and Fe in the catalyst according to one embodiment play a role of promoting oxidant oxidation, and A promotes catalyst activity. The addition of A improves catalyst activity compared to a catalyst including only Ru. In addition, A inhibits catalyst poisoning by the oxidant, particularly oxygen during the operation of fuel cells. Catalyst poisoning means a phenomenon where an oxidant surrounds active sites of a cathode catalyst such that the active sites do not participate in an oxidation reaction.

In one embodiment, the catalyst has an average particle diameter ranging from 2 to 5 nm, which is less than that of a conventional platinum-based catalyst or Ru— Se catalyst. Therefore, the active surface area of the catalyst increases, and catalyst activity may be improved.

The cathode catalyst according to an embodiment may be supported on a carrier or may be a black type catalyst that is not supported on a carrier. In one embodiment, when it is supported on a carrier, the amount of Ru—Fe-A ranges from 5 to 80 wt %. When the amount of Ru—Fe-A is less than 5 wt %, the catalyst content is too low to improve catalyst activity, whereas when it is more than 80 wt %, the carrier content is significantly low, and so conductivity may be deteriorated.

In one embodiment, the carrier may include carbon, such as activated carbon, denka black, ketjen black, acetylene black, graphite, or the like, or an inorganic material particulate such as alumina, silica, zirconia, titania, or the like. The carbon is generally used as a carrier.

The cathode catalyst according to one embodiment may be prepared as follows.

First, a ruthenium water-soluble salt and an iron water-soluble salt are mixed in a solvent. Examples of the ruthenium water-soluble salt include RuCl₃ hydrate, Ru(OH)₃, or RuFeCl₃.6H₂O, and examples of the iron water-soluble salt include Fe(NO₃)₃.9H₂O, or Fe(CH₃COO)₃. Examples of the solvent include water, acetone, or an alcohol such as methanol or ethanol.

During the above mixing process, in another embodiment, a carrier may be additionally used for a catalyst supported on a carrier. The carrier may be the above described carrier.

The amounts of the ruthenium water-soluble salt, iron water-soluble salt, and the carrier may be controlled in accordance with the desired catalyst composition.

The mixture of the salts is dried at 60 to 80° C. for 10 minutes to 1 day, and then is allowed to stand in a vacuum for about 4 hours. At this time, a certain temperature is required for dissolving the ruthenium water-soluble salt. For example, when the ruthenium water-soluble salt is a RuCl₃ hydrate, the temperature may be controlled to be greater than or equal to 140° C., preferably about 200° C.

An A source is added to the obtained mixture and heat-treated to prepare a cathode catalyst. Examples of the A source may be any organic metal compound including Se or S, and preferably H₂SeO₃.

The heat treatment temperature is 250 to 350° C. According to one embodiment, the heat treatment may be performed with flowing hydrogen gases. When the heat treatment is performed at more than 350° C., catalysts having thicknesses greater than or equal to 10 nm may be prepared, and catalyst activity may be deteriorated. In addition, in an embodiment, the heat treatment is performed for less than 12 hours, and preferably for 2 to 12 hours. When the heat treatment is performed for more than 12 hours, catalysts of more than 7 nm thick may be formed, and catalyst activity may be deteriorated.

According to another embodiment, a cathode catalyst includes a carbon-based material carrier, and crystalline M₁-M₂-Ch and amorphous M₁-M₂-Ch supported on the carbon-based material, where M₁ is a metal selected from the group consisting of Ru, Pt, Rh, and combinations thereof, M₂ is a metal selected from the group consisting of W, Mo, and combinations thereof, and Ch is a chalcogen element selected from the group consisting of S, Se, Te, and combinations thereof. The cathode catalyst has excellent activity and selectivity for use in an oxidant reduction reaction.

In one embodiment, M₁ is a metal selected from the group consisting of Ru, Pt, Rh, and combinations thereof, which is a platinum-based metal element having high activity for an oxidant reduction reaction. Oxygen in air is liable to adsorb to the metal and then form an oxide. Such oxides inhibit an active center of the metal for an oxidant reduction reaction and thereby make the oxidant reduction reaction difficult.

In an embodiment, Ch is a chalcogen element selected from the group consisting of S, Se, Te, and combinations thereof, which binds the Ru, Pt, or Rh to prevent oxygen in the air from adsorbing to the Ru, Pt, or Rh and forming an oxide.

In another embodiment, M₂ is a metal selected from the group consisting of W, Mo, and combinations thereof, which provides electrons to the Ru, Pt, or Rh to improve activity of the Ru, Pt, or Rh.

As a result, M₁-M₂-Ch has high activity and excellent selectivity for an oxidant reduction reaction, and thereby the cathode catalyst can maintain its internal performance even though a fuel is transferred to the cathode.

In an embodiment, in the M₁-M₂-Ch, the ratio of M₁ and M₂ ranges from 1:6 to 8. When the ratio of M₁ and M₂ is out of this range, catalyst activity may be deteriorated. In one embodiment, the ratio of M₁ and Ch ranges from 1:0.5 to 1. When the ratio of Ch with respect to M₁ is less than 0.5, selectivity for an oxidant reduction reaction may be deteriorated. When it is more than 1, catalyst activity may be deteriorated.

In the cathode catalyst according to an embodiment of the invention, M₁-M₂-Ch has both crystalline and amorphous phases, and thereby catalyst activity for an oxidant reduction reaction may be improved.

These improved results are caused because a surface energy of an active center at the interface between a crystalline M₁-M₂-Ch and an amorphous M₁-M₂-Ch is 10 to 50 times as high as that of an active center at a crystalline portion. Therefore, activity for an oxidant reduction reaction at the interface between crystalline and amorphous M₁-M₂-Ch is much higher.

In one embodiment, the amount of the amorphous M₁-M₂-Ch is 20 to 80 wt % of the entire M₁-M₂-Ch, preferably 30 to 70 wt %, and more preferably 40 to 60 wt %. When the amount of the amorphous M₁-M₂-Ch is more than 80 wt %, a M₁-M₂-Ch phase is not stable. When it is less than 20 wt %, catalyst activity may be deteriorated.

In one embodiment, the M₁-M₂-Ch itself may be aggregated and thus a small-sized particle may not be obtained. Therefore, it can be supported on a carbon-based material to increase the specific surface area.

In one embodiment, examples of the carbon-based materials include graphite, denka black, ketjen black, acetylene black, activated carbon, carbon nanotubes, carbon nanofibers, carbon nanowire, and combinations thereof.

The cathode catalyst according to an embodiment of the invention is prepared as follows: a metal M₁-containing water-soluble salt and a metal M₂-containing water-soluble salt are dissolved in a solvent to prepare a solution, the solution is mixed with carbon-based material powders, a first vacuum treatment is performed to prepare powders, the powders and a chalcogen element source are added to a solvent, a second vacuum treatment is performed to prepare powders, and then the powders are heat-treated.

First, the metal M₁-containing water-soluble salt and metal M₂-containing water-soluble salt are dissolved in a solvent and then carbon-based material powders are added. In an embodiment, a ruthenium-containing water-soluble salt as the metal M₁-containing water-soluble salt includes ruthenium chloride, ruthenium acetyl acetonate, or ruthenium carbonyl. In another embodiment, a tungsten-containing water-soluble salt as the metal M₂-containing water-soluble salt includes ammonium metatungstate. In an embodiment, the solvent includes water, acetone, or benzene. The carbon-based material may be the same as described above.

Then, the resulting mixture is subject to a first vacuum treatment. In an embodiment, the first vacuum treatment is performed at 100 to 300° C. for 1 to 24 hours.

The powders obtained by the first vacuum treatment and chalcogen element sources are added in a solvent and then a second vacuum treatment is performed. The solvent includes water, acetone, or benzene. In an embodiment, the chalcogen element sources include S powders, Se powders, Te powders, H₂SO₃, H₂SeO₃, and H₂TeO₃. In one embodiment, the second vacuum treatment is performed at 100 to 300° C. for 1 to 24 hours.

Finally, the obtained powders are heat treated. In one embodiment, the heat treatment is performed at 200 to 350° C. for 3 to 6 hours under a hydrogen atmosphere.

Through these processes, the cathode catalyst including crystalline and amorphous M₁-M₂-Ch phases is prepared.

According to another embodiment of the invention, a membrane-electrode assembly including the cathode catalyst is provided.

The membrane-electrode assembly includes an anode and a cathode facing each other and a polymer electrolyte membrane therebetween. The anode and the cathode each include a conductive electrode substrate and a catalyst layer disposed on the electrode substrate.

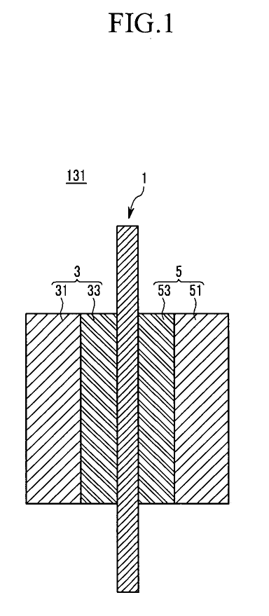

FIG. 1 is a schematic cross-sectional view showing a membrane-electrode assembly 131 according to one embodiment of the invention. Referring to the drawing, the membrane-electrode assembly 131 will be described.

The membrane-electrode assembly 131 generates electricity through fuel oxidation and oxidant reduction reactions and a plurality of membrane-electrode assemblies form a stack.

At a cathode catalyst layer 53, an oxidant reduction reaction occurs. The cathode catalyst layer 53 may include catalysts according to the embodiments above of the invention, and combinations thereof. The cathode catalyst has excellent activity and selectivity for an oxidant reduction reaction and thereby improves performances of a cathode 5 and the membrane-electrode assembly 131 including the cathode catalyst.

At an anode catalyst layer 33 of an anode 3, a fuel oxidation reaction occurs and a platinum-based catalyst may be used to promote the oxidation reaction. In one embodiment, examples of the platinum-based catalysts include platinum, ruthenium, osmium, platinum-ruthenium alloys, platinum-osmium alloys, platinum-palladium alloys, platinum-M alloys, or combinations thereof, where M is a transition element selected from the group consisting of Ga, Ti, V, Cr, Mn, Fe, Co, Ni, Cu, Zn, and combinations thereof.

The anode catalyst can be supported on a carbon carrier or not supported as a black type. In an embodiment, suitable carriers include carbon, such as graphite, denka black, ketjen black, acetylene black, activated carbon, carbon nanotubes, carbon nanofibers, and carbon nanowire, or inorganic material particulates, such as alumina, silica, zirconia, and titania. According to a preferred embodiment, carbon is used.

In an embodiment, the catalyst layers 33 and 53 of the anode 3 and the cathode 5 may include a binder. The binder may be any material that is generally used as a binder in an electrode of a fuel cell, such as polytetrafluoro ethylene, polyvinylidene fluoride, polyvinylidene chloride, polyvinyl alcohol, cellulose acetate, poly(perfluorosulfonic acid), and so on.

Electrode substrates 31 and 51 play a role of supporting an electrode, and also of spreading a fuel and an oxidant to the catalyst layers 33 and 53 to help the fuel and oxidant to easily approach the catalyst layers 33 and 53. In an embodiment, for the electrode substrates 31 and 51, a conductive substrate is used, for example carbon paper, carbon cloth, carbon felt, or metal cloth (a porous film comprising metal cloth fiber or a metalized polymer fiber), but it is not limited thereto.

In one embodiment, the electrode substrates 31 and 51 may be treated with a fluorine-based resin to be water-repellent, which can prevent deterioration of reactant diffusion efficiency due to water generated during a fuel cell operation. In an embodiment, the fluorine-based resin includes polyvinylidene fluoride, polytetrafluoroethylene, fluorinated ethylene propylene, polychlorotrifluoroethylene, fluoroethylene polymers, and so on.

In an embodiment, a micro-porous layer (MPL) can be added between the electrode substrate 31 and 51 and the catalyst layers 33 and 53 to increase reactant diffusion effects. In general, the microporous layer may include, but is not limited to, a small sized conductive powder, such as a carbon powder, carbon black, acetylene black, activated carbon, carbon fiber, fullerene, nano-carbon, or a combination thereof.

In an embodiment, the nano-carbon may include materials such as carbon nanotubes, carbon nanofibers, carbon nanowire, carbon nanohorns, carbon nanorings, or combinations thereof. The microporous layer is formed by coating a composition including a conductive powder, a binder resin, and a solvent onto the conductive substrate. The binder resin may include, but is not limited to, polytetrafluoroethylene, polyvinylidenefluoride, polyvinylalcohol, celluloseacetate, and combinations thereof. The solvent may include, but is not limited to, an alcohol such as ethanol, isopropyl alcohol, ethyl alcohol, n-propyl alcohol, or butyl alcohol; water; dimethylacetamide; dimethylsulfoxide; and N-methylpyrrolidone. The coating method may include, but is not limited to, screen printing, spray coating, doctor blade methods, gravure coating, dip coating, silk screening, and painting, depending on the viscosity of the composition.

The polymer electrolyte membrane 1 functions as an ion exchange, transferring protons generated in the anode catalyst layer 33 to the cathode catalyst layer 53, and thus, can include a highly proton-conductive polymer.

In one embodiment, the proton-conductive polymer may be a polymer resin having a cation exchange group selected from the group consisting of a sulfonic acid group, a carboxylic acid group, a phosphoric acid group, a phosphonic acid group, and derivatives thereof, at its side chain.

In an embodiment, the polymer electrolyte membrane 1 may include at least one selected from the group consisting of fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In one embodiment, the polymer electrolyte membrane includes proton conductive polymers selected from the group consisting of poly(perfluorosulfonic acid) (NAFION™), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), or poly(2,5-benzimidazole). In an embodiment, in general, the polymer membrane has a thickness ranging from 10 to 200 μm.

Hydrogens (H) of proton-conductive groups of the proton-conductive polymer can be substituted with Na, K, Li, Cs, tetrabutylammonium, or combinations thereof. When the H in the ionic exchange group of the terminal end of the proton-conductive polymer side is substituted with Na or tetrabutylammonium, NaOH or tetrabutyl ammonium hydroxide may be used, respectively. When the H is substituted with K, Li, or Cs, suitable compounds for the substitutions may be used. Since such substitutions are known in the art, its detailed description is omitted.

A fuel cell system including the membrane-electrode assembly of the invention includes at least one electricity generating element, a fuel supplier, and an oxidant supplier.

The electricity generating element includes a membrane-electrode assembly and separators disposed at each side of the membrane-electrode assembly. It generates electricity through oxidation of a fuel and reduction of an oxidant.

The fuel supplier plays a role of supplying the electricity generating element with a fuel including hydrogen and the oxidant supplier plays a role of supplying the electricity generating element with an oxidant. In an embodiment, the fuel includes liquid or gaseous hydrogen, or a hydrocarbon-based fuel such as methanol, ethanol, propanol, butanol, or natural gas. The oxidant includes oxygen. Therefore, pure oxygen or air can be used. The fuel and the oxidant are not limited to the above.

A fuel cell system according to the invention can be applied to a polymer electrolyte fuel cell (PEMFC) and a direct oxidation fuel cell (DOFC). Since the cathode catalyst has excellent selectivity for an oxygen reduction reaction, it can effectively be applied to a direct oxidation fuel cell such as a direct methanol fuel cell that has fuel cross-over problems.

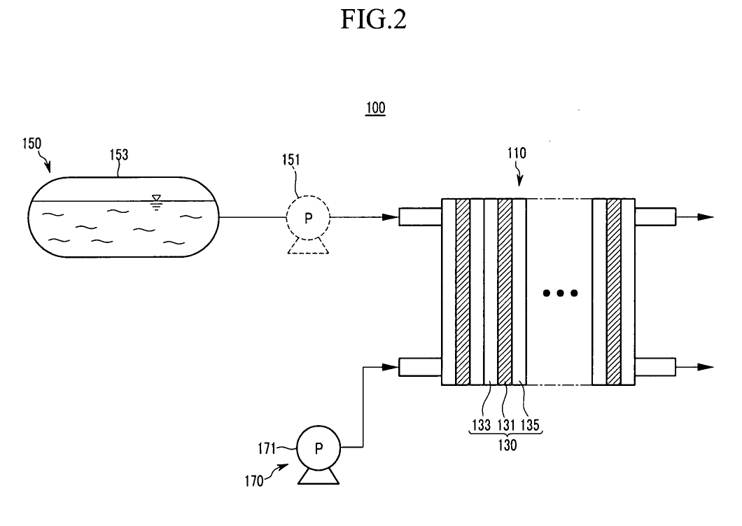

FIG. 2 shows a schematic structure of a fuel cell system 100 that will be described in detail with reference to the accompanying drawing as follows. FIG. 2 illustrates a fuel cell system 100 wherein a fuel and an oxidant are provided to an electricity generating element 130 through pumps 151 and 171, but the invention is not limited to such structures. The fuel cell system of the invention may alternatively include a structure wherein a fuel and an oxidant are provided in a diffusion manner.

The fuel cell system 100 includes a stack 110 comprising at least one electricity generating element 130 that generates electrical energy through an electrochemical reaction of a fuel and an oxidant, a fuel supplier 150 for supplying a fuel to the electricity generating element 130, and an oxidant supplier 170 for supplying the oxidant to the electricity generating element 130.

In addition, the fuel supplier 150 is equipped with a tank 153, which stores fuel, and a pump 151, which is connected therewith. The fuel pump 151 supplies the fuel stored in the tank 153 with a predetermined pumping power.

The oxidant supplier 170, which supplies the electricity generating element 130 of the stack 110 with the oxidant, is equipped with at least one pump 171 for supplying the oxidant with a predetermined pumping power.

The electricity generating element 130 includes a membrane-electrode assembly 131 that oxidizes hydrogen or a fuel and reduces an oxidant, separators 133 and 135 that are respectively positioned at opposite sides of the membrane-electrode assembly 131 and supply hydrogen or a fuel, and an oxidant.

The following examples illustrate the invention in more detail. However, it is understood that the invention is not limited by these examples.

### Example 1

0.8 g of RuCl₃ hydrate and 1.2 g of Fe(NO₃)₃.9H₂O were dissolved in 4 ml of water. The solution was supported on 1 g of a carbon carrier. The resulting product was dried at 70° C. for 24 hours at normal pressure, and was dried again at 140° C. for 24 hours under a vacuum. The dried sample was heat treated under an H₂ and N₂ mixed gas atmosphere (1:1 volume ratio) at 300° C. for 4 hours to prepare RuFe (RuFe/C) supported on a carbon.

Next, 0.06 g of H₂SeO₃ was dissolved in 2 ml of water. The solution was supported on the prepared RuFe/C. The resulting product was dried at 70° C. for 24 hours at a normal pressure, and was dried again at 140° C. for 24 hours under a vacuum. The dried sample was heat treated under an H₂ and N₂ mixed gas atmosphere (1:1 volume ratio) at 300° C. for 4 hours.

### Comparative Example 1

A cathode catalyst for a fuel cell was prepared using the same method as in Example 1, except that Fe(NO₃)₃.9H₂O was not used.

### Example 2

1 g of ruthenium chloride and 3 g of ammonium metatungstate were dissolved in 4 ml of water, and then, 1 g of ketjen black was added in the prepared solution followed by mixing. The prepared mixed solution was subject to a first vacuum treatment at 150° C. for 12 hours. The resulting powder obtained from the first vacuum treatment was mixed with 4 ml of 0.0075% concentration selenium acid solution. The mixture was homogenously mixed. Next, the resulting solution obtained from the mixing process was subject to a second vacuum treatment at 150° C. for 12 hours. The resulting powder obtained from the second vacuum treatment was heat treated at 250° C., for 3 hours under hydrogen gas atmosphere to prepare a cathode catalyst for a fuel cell.

### Comparative Example 2

0.6 g of ruthenium carbonyl and 0.6 g of tungsten carbonyl were dissolved in 150 ml of benzene. 0.01 g of a selenium powder and 1 g of ketjen black were added in the prepared solution and agitated for 24 hours with refluxing, followed by washing and drying at 80° C. for 12 hours. The obtained powder was heat treated at 250° C. for 3 hours under hydrogen atmosphere to prepare a cathode catalyst for a fuel cell.

The catalyst according to Comparative Example 2 was crystalline Ru—W—Se supported on ketjen black. The catalyst according to Example 2 was crystalline and amorphous Ru—W—Se supported on ketjen black.

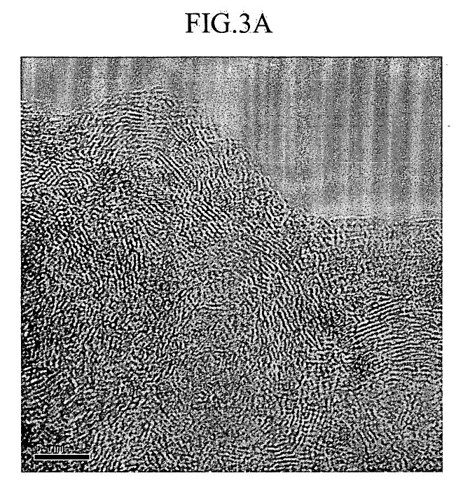

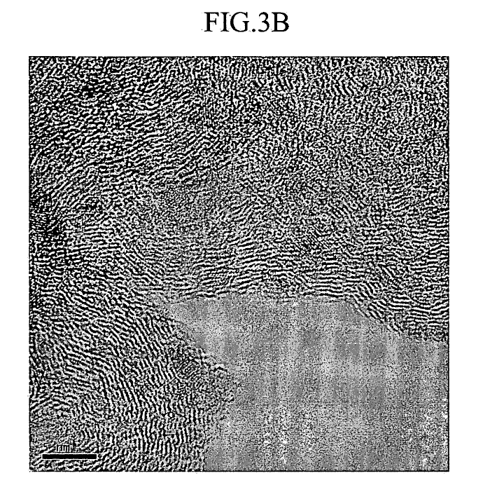

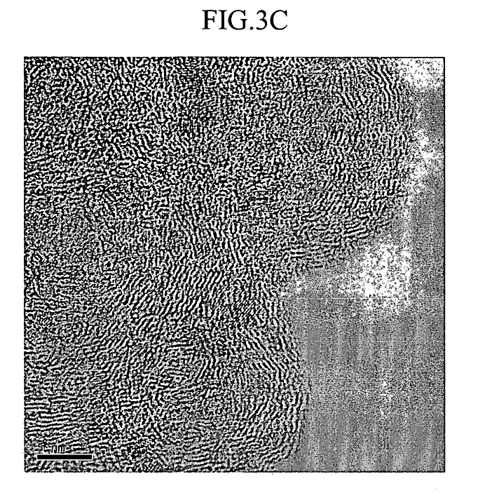

FIGS. 3A to 3C are SEM photographs of a cathode catalyst prepared according to Example 1 taken from various orientations. The darkest parts of FIGS. 3A to 3C correspond to a crystalline phase. The brighter parts indicate that the crystalline phase is lessened and changed to form an amorphous phase. Therefore, the brightest parts correspond to an amorphous phase. Further, the scale bar of FIGS. 3A to 3C represents 5 nm, and so the size of the crystalline phase, which is the darkest part, is 3 to 4 nm.

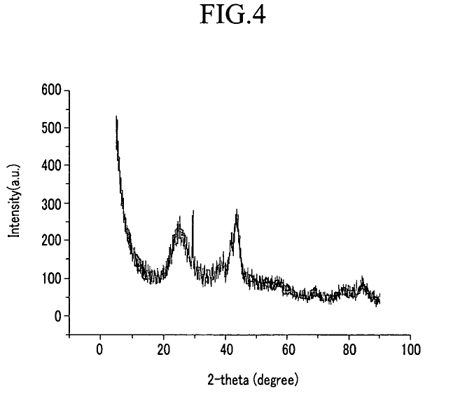

FIG. 4 is a graph showing an X-Ray diffraction analysis result of the catalyst according to Example 2. As shown in FIG. 4, there are three high peaks, and the peak at 27 degrees indicates a carbon peak, the peak at 30 degrees indicates a tungsten peak, and the peak at 45 degrees indicates a ruthenium peak. The other small peaks that are widely distributed indicate ruthenium peaks. A selenium peak did not appear.

The above results indicate that the amount of selenium is very small, and all of the selenium particles are positioned on a ruthenium-tungsten alloy. The main peaks of tungsten at 30 degrees and ruthenium at 45 degrees have the same intensity as the carbon peak. Since the carbon is amorphous, tungsten and ruthenium also exist in a similar phase to an amorphous phase. Further, a ruthenium particle size is very small from the fact that the ruthenium peak is wide. The ruthenium particle size is about 2.5 to 3.5 nm.

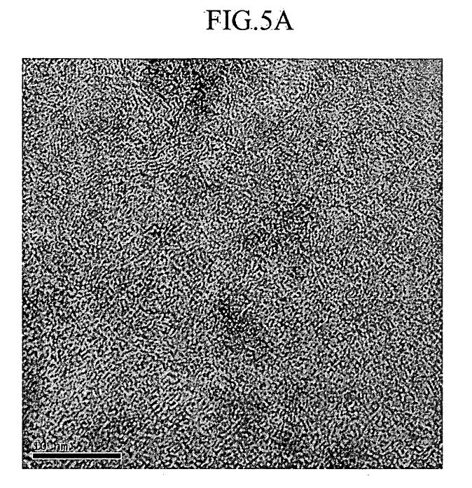

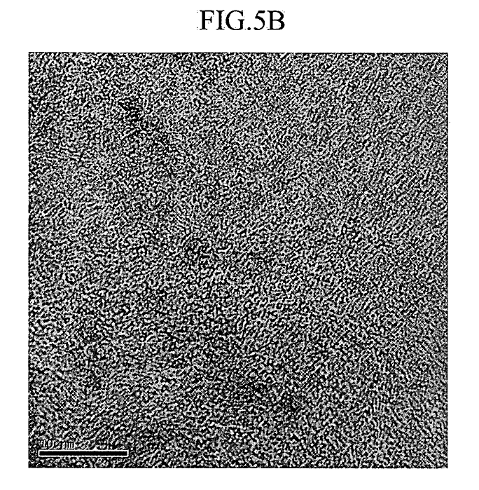

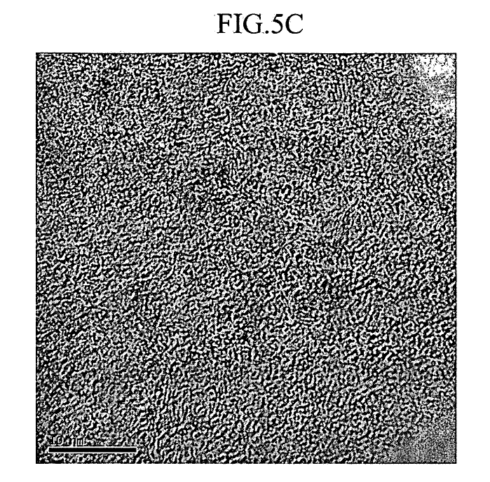

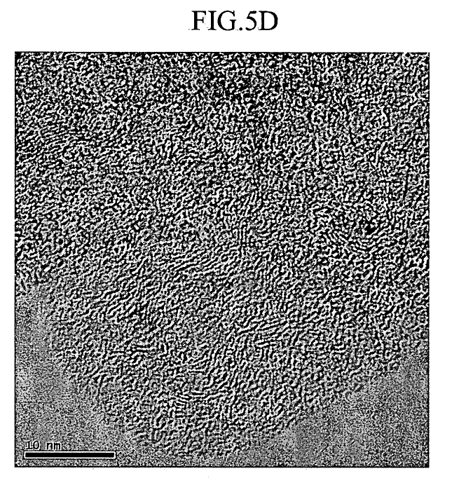

FIGS. 5A to 5D are TEM photographs showing a catalyst according to Example 2. FIGS. 5A to 5D show four different parts of a catalyst according to Example 2 in order to ensure reliability. As shown in FIG. 5A to 5D, the dark spots represent Ru—W—Se, and the gray parts, which are widely distributed, represent amorphous carbon. The dark spots of Ru—W—Se are distinguished by brightness and darkness. The darker parts indicate that the phase is near a crystalline phase. A catalyst according to Example 2 includes a mixed phase of a crystalline Ru—W—Se and an amorphous Ru—W—Se.

The reduction/oxidation efficiency of a fuel cell using a cathode catalyst prepared according to Example 1 and Comparative Example 1 was measured using a Rotating Disk Electrode (RDE). Ag/AgCl was used as a reference electrode, Pt was used as a counter electrode, and 0.5M sulfuric acid solution was used. The efficiency was measured at 10 mV/s of scan rate and 2000 rpm of rotating speed.

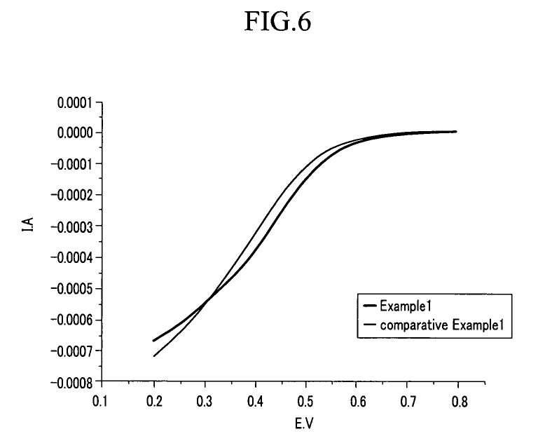

FIG. 6 shows the result. As shown in FIG. 6, a fuel cell using a cathode catalyst according to Example 1 has more effective oxidant reduction compared to a fuel cell using a catalyst according to Comparative Example 1.

To examine the catalyst activity of Example 2 and Comparative Example 2, oxygen saturated sulfuric acid solution was prepared by bubbling an oxygen gas for 2 hours in a 0.5M concentration sulfuric acid solution. Working electrodes were prepared by loading 3.78×10⁻³ mg of catalysts according to Example 2 and Comparative Example 2 on glassy carbons, respectively, and a platinum mesh was used as a counter electrode. The working and counter electrodes were put in the sulfuric acid solution and current density was measured while changing the voltage.

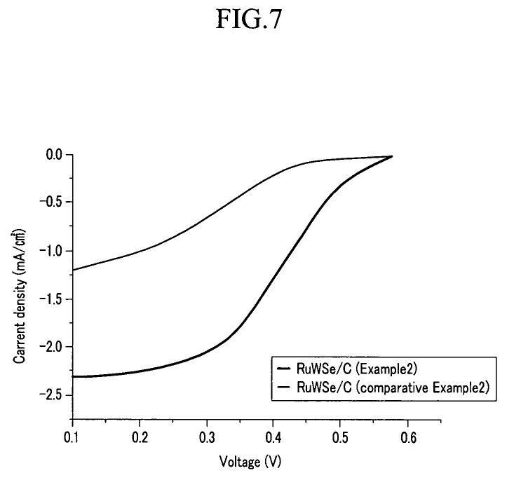

FIG. 7 shows a curved line of a current density in accordance with a voltage change of catalysts according to Example 2 and Comparative Example 2. As shown in FIG. 7, the catalyst according to Example 2 has more improved activity than the catalyst according to Comparative Example 2.

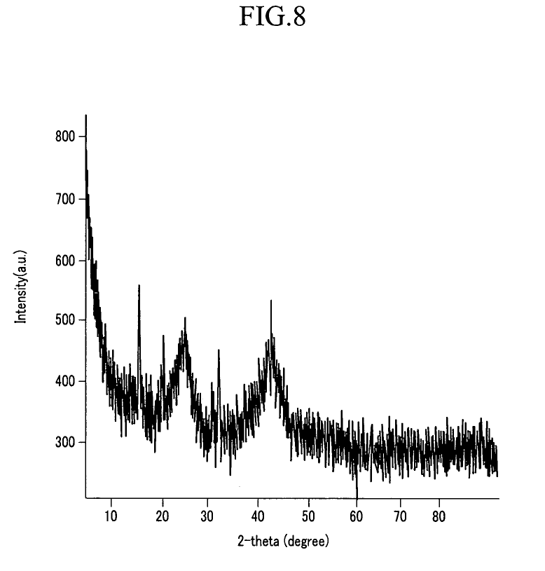

An X-ray diffraction peak of the catalyst according to Example 1 was measured in order to confirm that the catalyst was semi-amorphous, and the results are shown in FIG. 8. As shown in FIG. 8, the prepared catalyst is semi-amorphous from the small peaks combined with each other compared to a crystalline sharp peak.

A cathode catalyst for a fuel cell of the invention has an amorphous shape, and has high catalyst efficiency. Further, a cathode catalyst for a fuel cell of the invention has excellent activity and selectivity for an oxidant reduction, and therefore, a membrane-electrode assembly for a fuel cell and a fuel cell system including the same may have an improved performance.

While this invention has been described in connection with what are considered to be exemplary embodiments, it is to be understood that the invention is not limited to the disclosed embodiments, but, on the contrary, is intended to cover various modifications and equivalent arrangements included within the spirit and scope of the appended claims.

What is claimed is:

1. A cathode catalyst for a fuel cell comprising Ru, Fe, and A, wherein A is selected from the group consisting of Se and S.

2. The cathode catalyst of claim 1, wherein the cathode catalyst is semi-amorphous.

3. The cathode catalyst of claim 1, wherein A is present in an amount in the range of 3 to 5 mol %.

4. The cathode catalyst of claim 1, wherein Ru is present in an amount in the range of 15 to 70 mol %.

5. The cathode catalyst of claim 1, wherein Fe is present in an amount in the range of 15 to 70 mol %.

6. The cathode catalyst of claim 1, wherein the cathode catalyst has an average particle diameter in the range of 2 to 5 nm.

7. The cathode catalyst of claim 1, wherein the cathode catalyst is supported on a carrier or a black-type catalyst.

8. The cathode catalyst of claim 7, wherein the catalyst is supported on a carrier in an amount in the range of 5 to 80 wt %.

9. A cathode catalyst for a fuel cell comprising:
a carbon-based material; and
crystalline M₁-M₂-Ch and amorphous M₁-M₂-Ch supported on the carbon-based material,
wherein M₁ is a metal selected from the group consisting of Ru, Pt, Rh, and combinations thereof, M₂ is a metal selected from the group consisting of W, Mo, and combinations thereof, and Ch is a chalcogen element selected from the group consisting of S, Se, Te, and combinations thereof.

10. The cathode catalyst of claim 9, wherein the amount of the crystalline M₁-M₂-Ch is in the range of 20 to 80 wt % and the amount of the amorphous M₁-M₂-Ch is in the range of 20 to 80 wt %.

11. The cathode catalyst of claim 10, wherein the amount of the crystalline M₁-M₂-Ch is in the range of 30 to 70 wt % and the amount of the amorphous M₁-M₂-Ch is in the range of 30 to 70 wt %.

12. The cathode catalyst of claim 11, wherein the amount of the crystalline M₁-M₂-Ch is in the range of 40 to 60 wt % and the amount of the amorphous M₁-M₂-Ch is in the range of 40 to 60 wt %.

13. The cathode catalyst of claim 9, wherein a ratio of M₁ and M₂ is in the range of 1:6 to 8.

14. The cathode catalyst of claim 9, wherein a ratio of M₁ and Ch is in the range of 1:0.5 to 1.

15. The cathode catalyst of claim 9, wherein the carbon-based material is selected from the group consisting of graphite, denka black, ketjen black, acetylene black, activated carbon, carbon nanotubes, carbon nanofibers, carbon nanowire, and combinations thereof.

16. A membrane-electrode assembly for a fuel cell comprising:
an anode and a cathode facing each other; and
a polymer electrolyte membrane interposed between the anode and cathode,
wherein the cathode comprises a catalyst comprising Ru, Fe, and A, where A is selected from the group consisting of Se and S.

17. The membrane-electrode assembly of claim 16, wherein the catalyst is semi-amorphous.

18. The membrane-electrode assembly of claim 16, wherein A is present in an amount in the range of 3 to 5 mol %.

19. The membrane-electrode assembly of claim 16, wherein Ru is present in an amount in the range of 15 to 70 mol %.

20. The membrane-electrode assembly of claim 16, wherein Fe is present in an amount in the range of 15 to 70 mol %.

21. The membrane-electrode assembly of claim 16, wherein the catalyst has an average particle diameter in the range of 2 to 5 nm.

22. The membrane-electrode assembly of claim 16, wherein the catalyst is supported on a carrier or is a black-type catalyst.

23. The membrane-electrode assembly of claim 22, wherein the catalyst is supported on a carrier in an amount in the range of 5 to 80 wt %

24. A membrane-electrode assembly comprising:
an anode and a cathode facing each other; and
a polymer electrolyte membrane interposed between the anode and cathode,
wherein the cathode comprises:
a conductive electrode substrate; and
a catalyst layer disposed on the electrode substrate comprising
a carbon-based material, and
crystalline M₁-M₂-Ch and amorphous M₁-M₂-Ch supported on the carbon-based material,
wherein M₁ is a metal selected from the group consisting of Ru, Pt, Rh, and combinations thereof, M₂ is a metal selected from the group consisting of W, Mo, and combinations thereof, and Ch is a chalcogen element selected from the group consisting of S, Se, Te, and combinations thereof.

25. The membrane-electrode assembly of claim 24, wherein the amount of the crystalline M₁-M₂-Ch is in the range of 20 to 80 wt % and the amount of the amorphous M₁-M₂-Ch is in the range of 20 to 80 wt %.

26. The membrane-electrode assembly of claim 25, wherein the amount of the crystalline M₁-M₂-Ch is in the range of 30 to 70 wt % and the amount of the amorphous M₁-M₂-Ch is in the range of 30 to 70 wt %.

27. The membrane-electrode assembly of claim 26, wherein the amount of the crystalline M₁-M₂-Ch is in the range of 40 to 60 wt % and the amount of the amorphous M₁-M₂-Ch is in the range of 40 to 60 wt %.

28. The membrane-electrode assembly of claim 24, wherein a ratio of M₁ and M₂ is in the range of 1:6 to 8.

29. The membrane-electrode assembly of claim 24, wherein a ratio of M₁ and Ch is in the range of 1:0.5 to 1.

30. The membrane-electrode assembly of claim 24, wherein the carbon-based material is selected from the group consisting of graphite, denka black, ketjen black, acetylene black, activated carbon, carbon nanotubes, carbon nanofibers, carbon nanowire, and combinations thereof.

31. A fuel cell system comprising:
at least one electricity generating element comprising
a membrane-electrode assembly comprising
an anode and a cathode facing each other, and
a polymer electrolyte membrane interposed between the anode and cathode,
wherein the cathode comprises a catalyst comprising Ru, Fe, and A, where A is selected from the group consisting of Se and S, and
separators arranged at each side of the membrane-electrode assembly;
a fuel supplier for supplying a fuel to the electricity generating element; and
an oxidant supplier for supplying an oxidant to the electricity generating element.

32. The fuel cell system of claim 31, wherein the fuel cell system is a polymer electrolyte fuel cell or a direct oxidation fuel cell.

33. A fuel cell system comprising:
at least one electricity generating element comprising
a membrane-electrode assembly comprising
an anode and a cathode facing each other, and
a polymer electrolyte membrane interposed between the anode and cathode,
wherein the cathode comprises
a conductive electrode substrate, and
a catalyst layer disposed on the electrode substrate comprising
a carbon-based material, and
crystalline M₁-M₂-Ch and amorphous M₁-M₂-Ch supported on the carbon-based material,
wherein M₁ is a metal selected from the group consisting of Ru, Pt, Rh, and combinations thereof, M₂ is a metal selected from the group consisting of W, Mo, and combinations thereof, and Ch is a chalcogen element selected from the group consisting of S, Se, Te, and combinations thereof, and
separators arranged at each side of the membrane-electrode assembly;
a fuel supplier for supplying a fuel to the electricity generating element; and
an oxidant supplier for supplying an oxidant to the electricity generating element.

34. The fuel cell system of claim 33, wherein the fuel cell system is a polymer electrolyte fuel cell or a direct oxidation fuel cell.
